(19) United States
(12) Patent Application Publication
(10) Pub. No.: US 2019/0197140 A1
(43) Pub. Date: Jun. 27, 2019

(54) AUTOMATION OF SQL TUNING METHOD AND SYSTEM USING STATISTIC SQL PATTERN ANALYSIS

(71) Applicant: Warevalley Co., Ltd., Seoul (KR)

(72) Inventors: Hyun ki LEE, Seoul (KR); Kyung mi LEE, Gyeonggi-do (KR)

(21) Appl. No.: 16/168,665

(22) Filed: Oct. 23, 2018

(30) Foreign Application Priority Data
Dec. 22, 2017 (KR) 10-2017-0178654
Sep. 5, 2018 (KR) 10-2018-0105809

(51) Int. Cl. G06F 17/30; G06F 11/34; H04L 12/26; H04L 29/08

(52) U.S. Cl. CPC G06F 17/30306; G06F 11/3452; H04L 67/28; H04L 43/12; G06F 17/30598

(57) ABSTRACT

A structured query language (SQL) tuning automation method and a system therefor, which are capable of extracting SQL attribute information from a network stream transmitted and received between a client and a database and proposing improved measures of an SQL through a statistical analysis. The tuning automation system includes an operating server configured to operate a database and a monitoring server configured to monitor performance by extracting transaction information including SQLs, a response time, and a processing result from a network stream transmitted between a client and the database of the operating server, find a cause of performance degradation, and propose improvement measures. The monitoring server includes a sniffing module configured to capture packets transmitted and received between the client and the operating server, a proxy module configured to relay a connection between the client and the operating server and collect packets, a packet analysis module configured to analyze the packets captured by the sniffing module and the proxy module and extract transaction information, a transaction analysis module configured to analyze user information, a connection DBMS server, an SQL, and a table, a column, a function, a data amount, a conditional clause, a join table, a processing result, and a processing time which are used in the SQL from the extracted transaction information, and an optimizing module configured to propose improvement measures using the extracted transaction information and statistical information.

### CROSS-REFERENCE TO RELATED APPLICATIONS

This application claims priority to and the benefit of Korean Patent Application No. 2017-0178654, filed on Dec. 22, 2017 and Korean Patent Application No. 2018-0105809, filed on Sep. 5, 2018, the disclosures of which are incorporated herein by reference in their entirety.

### FIELD

The present invention relates to a structured query language (SQL) tuning automation method and a system therefor, and more particularly, to a SQL tuning automation method and a system therefor, which are capable of collecting SQLs from a network stream transmitted and received between a client and a database and analyzing a processing time of SQLs, a size of data, and the like to propose improvement measures for the collected SQLs using the analysis result.

### BACKGROUND

As the mobile age evolved beyond the information age, the use of data base management system (DBMS) has been increasing again. Consequently, as the number of systems using a database increases and the software development cycle becomes shorter, a lot of costs occur for managing database performance and database management by the human is limited so that a system specialized in database performance management is required.

Korean Patent Registration No. 10-0481130, entitled “Database System Monitoring Method Without Connecting the Database System,” discloses that, when data packets are transmitted and received according to a network protocol, the data packets are collected through sniffing by a monitoring process and all of SQL information and database performance information, which are transmitted between an operating server and a client application process, are extracted.

Further, Korean Patent Registration No. 10-1737578, entitled “Method and Device for Automatically Tuning for SQL Sentences Generated Automatically,” discloses a method including extracting source location identification information on data stored in a source server and target location identification information on a location at which the data will be stored in a target server, generating a mapping logic by applying the source location identification information and the target location identification information to a transfer logic including a phrase for transferring the data to the target server, and reconfiguring a conditional sentence included in the mapping logic to rapidly perform a data transfer faster than a transfer rate when a data transfer is performed according to the generated mapping logic.

However, such conventional monitoring systems are difficult to apply to a proxy system and functions thereof are limited to a specific task such as a data transfer task and the like so that a demand for a monitoring system using an improved statistical technique is increasing.

### SUMMARY

It is an objective of the present invention to provide a structured query language (SQL) tuning automation method and a system therefor, which are capable of extracting transaction information including SQLs transmitted and received between a client terminal and a database, a response time, and a processing result using a sniffing method and a proxy method and analyzing a current state and a performance problem of the database using the extracted transaction information, response time, and processing result, thereby proposing improvement measures.

It is another object of the present invention to provide a SQL tuning automation method and a system therefor, which are capable of systemizing all operations of seeking improvement measures while continuously performing monitoring and verifying the improvement measures to rapidly manage a performance problem when the performance problem occurs through a statistical SQL pattern analysis while hardly imposing a load on a database system.

A structured query language (SQL) tuning automation system according to an embodiment of the present invention includes an operating server configured to operate a database, and a monitoring server configured to monitor performance by extracting transaction information including SQLs, a response time, and a processing result from a network stream transmitted between a client and the database of the operating server, analyze a cause of performance degradation, and propose improvement measures.

A sniffing module of the monitoring server may capture packets transmitted and received between the client and the operating server, and a proxy module may relay a connection between the client and the operating server and collect packets. A packet analysis module may analyze the packets captured by the sniffing module and the proxy module and extract transaction information.

A transaction analysis module may analyze user information, a connection data base management system (DBMS) server, an SQL, and a table, a column, a function, a data amount, a conditional clause, a join table, a processing result, and a processing time which are used in the SQL from the extracted transaction information and store SQL attribute information in a repository.

An optimizing module may classify a fast SQL group and a slow SQL group on the basis of an average processing time stored in the repository, analyzes a characteristic of the SQL for the same table by referring to a synonym dictionary and a previous optimization history, and propose improvement measures by reflecting a characteristic of a fast SQL to that of a slow SQL.

A verification module may compare and verify the improvement measures with a source SQL in an actual database.

An SQL tuning method according to an embodiment of the present invention includes a first operation of acquiring, by a performance monitoring server, packets from a network when the packets are transmitted and received between a user and a database, a second operation of analyzing the acquired packets to extract transaction information, a third operation of calculating user information, a connection data base management system (DBMS) server, an SQL, and a table, a column, a function, a data amount, a conditional clause, a join table, a processing result, and a processing time which are used in the SQL from the extracted transaction information, a fourth operation of seeking improvement measures using the analyzed information, and a fifth operation of verifying the improvement measures, wherein the improvement measures are proposed by monitoring a target monitoring database and analyzing a cause of performance degradation.

The fourth operation of seeking the improvement measures may include determining values of a table, a column, a function, a conditional clause, a join table, a result value, an elapsed time which are used in the SQL, extracting a relationship between the elapsed time and SQL attribute values using the determined values as SQL attributes through a data mining technique, and generating a new SQL by applying predefined improvement measures to a corresponding cause using the extracted elapsed time and the extracted SQL attribute values.

The first operation of acquiring the packets from the network may use a sniffing method and a proxy method.

### Advantageous Effects

The SQL tuning automation method according to the present embodiment can acquire packets transmitted between a user and a database without affecting performance of a database operating system using a sniffing method and a proxy method, automate most of a database monitoring and performance improvement using the acquired packets, reduce the burden on administrator, and reduce DBMS operation cost and time.

Further, unlike a conventional method, it is possible to support a DBMS in which a system catalog support is insufficient using a statistical method without referring to a catalog.

### BRIEF DESCRIPTION OF THE DRAWINGS

FIG. 1 is a schematic diagram of a database performance monitoring system according to an embodiment of the present invention.

FIG. 2 is a block diagram illustrating a detailed configuration of a performance monitoring server according to an embodiment of the present invention.

FIG. 3 is a flowchart illustrating a method of extracting transaction information and seeking improvement measures by capturing and selecting packets in the performance monitoring system according to an embodiment of the present invention.

FIG. 4 is a detailed flowchart illustrating the method of seeking the improvement measures in the performance monitoring system according to the embodiment of the present invention.

FIG. 5 is a flowchart illustrating a process of verifying the improvement measures according to the embodiment of the present invention.

### DETAILED DESCRIPTION

The above and other technical objects, features, and advantages of the present invention will become more apparent from preferred embodiments of the present invention, which are described below, when taken in conjunction with the accompanying drawings. The following embodiments are merely illustrative of the present invention and are not intended to limit the scope of the present invention.

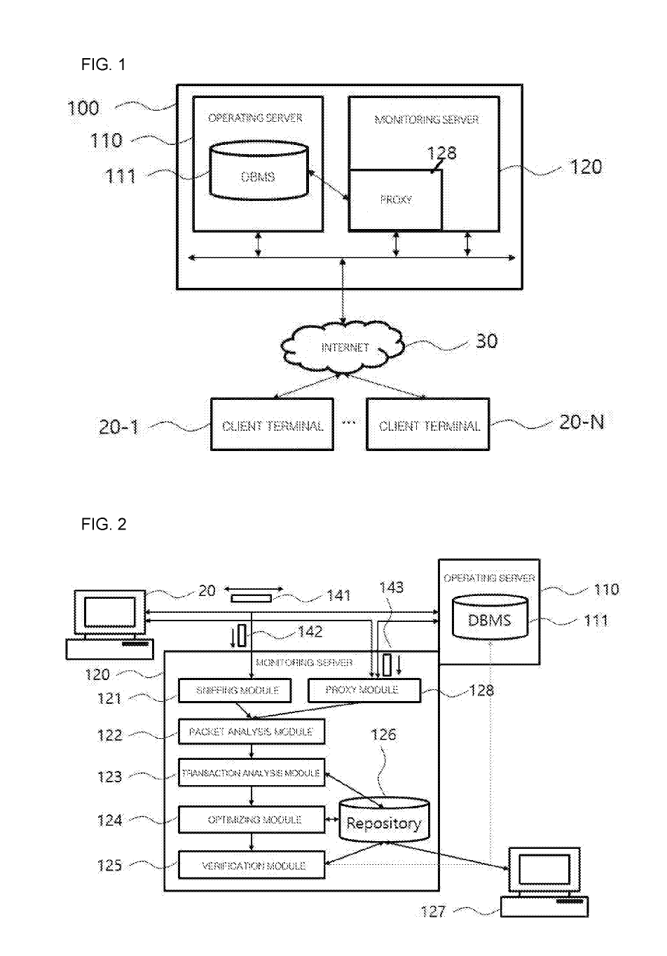

FIG. 1 is a schematic diagram of a database performance monitoring system for monitoring and improving database performance by collecting packets while capturing the packets by a sniffing method or relaying a connection by a proxy method using a separate performance monitoring server 120.

As shown in FIG. 1, a database performance monitoring and structured query language (SQL) tuning automation system 100 using a network packet collecting method of sniffing and proxy according to the embodiment of the present invention includes an operating server 110 for operating a database, a plurality of client terminals 20-1 to 20-N for communicating with a database 111 through the Internet 30, and the monitoring server 120 for performing monitoring by extracting transaction information between the DBMS 111 of the operating server 110 and the client terminals 20-1 to 20-N from a network stream.

Referring to FIG. 1, a user may connect to the DBMS 111 of the operating server 110 using the client terminals 20-1 to 20-N, or may connect to the DBMS of the operating server through a proxy module 128 of the monitoring server. The monitoring server 120 extracts and analyzes packets captured from the network stream using a sniffing method and a packet 143 collected when the user connects to the operating server 110 through the proxy module 128 to provide the user with improvement measures.

FIG. 2 is a block diagram illustrating a detailed configuration of the performance monitoring server 120 according to an embodiment of the present invention.

As shown in FIG. 2, the performance monitoring server 120 according to the embodiment of the present invention includes a sniffing module 121, a packet analysis module 122, a transaction analysis module 123, an optimizing module 124, a verification module 125, a repository 126, and a proxy module 128.

Referring to FIG. 2, the sniffing module 121 captures a packet 141 transmitted and received between a client 20 and the operating server 110, and the proxy module 128 collects the packet 143 while relaying a connection between the client 20 and the operating server 110.

The packet analysis module 122 analyzes a packet 142 captured in the sniffing module 121 and the packet 143 collected in the proxy module 128 to extract transaction information.

The transaction analysis module 123 extracts information required for seeking a performance analysis and improvement measures using the transaction information extracted from the collected packets 142 and 143 and stores the extracted information in the form of a table in the repository 126. That is, transaction analysis module 123 finds SQL attribute information, such as a user of each session, a requested SQL, and a table, a column, a used function, a join table, a data size of a lookup result, and a processing time of a corresponding SQL, and calculates a statistical value to store the SQL attribute information and the statistical value in the repository 126. An example of a SQL attribute information table stored in the repository 126 is shown in the following table, Table 1.

TABLE 1

| | Processing | | | Join | | Data |
|---|---|---|---|---|---|---|
| Items | time | Table | Lookup column | Sequence | Conditional clause | Size |
| SQL#1 | 1 s | Table1 | Col1, Col2 | 1 | Col1 like ‘abcd %’ | 100 |
| SQL#2 | 2 s | Table2 | Col1, Col2, Col3 | 1 | Col2 > Col3 | 1024 |
| SQL#3 | 30 s | Table1 | Col1, Col2 | 1 | Instr(col1, ‘abcd’) = 1 | 100 |

The optimizing module 124 finds correlation between the collected SQLs, various data, the statistical value, and the processing time, analyzes a cause of process speed degradation, and provides an SQL to which predefined improvement measures for the cause are reflected. For example, the optimizing module 124 classifies a fast SQL group and a slow SQL group on the basis of an average processing time, analyzes a characteristic of the SQL for the same table by referring to a synonym dictionary and a previous optimization history, and reflects a characteristic of a fast SQL to that of a slow SQL.

The verification module 125 compares and tests a source SQL stored in the repository 126 with an improved SQL in the DBMS 111 to determine whether improvement is made, and feeds the result value back to the optimizing module 124 for reference to performance improvement.

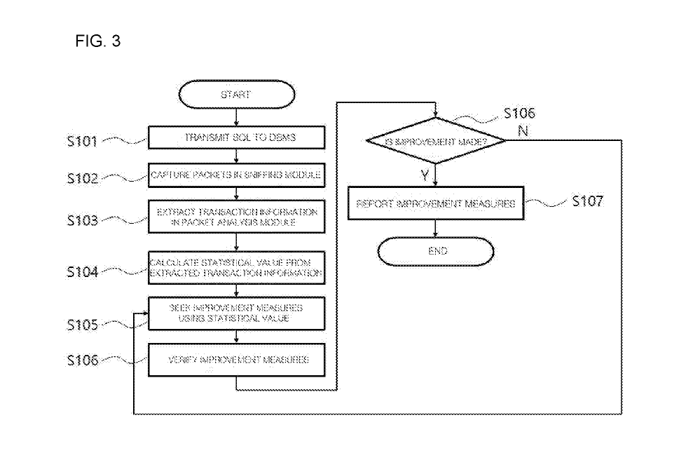

FIG. 3 is a flowchart illustrating a method of extracting transaction information and seeking improvement measures by capturing and selecting packets in the performance monitoring system according to an embodiment of the present invention.

Referring to FIG. 3, when the client terminals 20-1 to 20-N transmit SQLs to the DBMS 111, the sniffing module 121 or the proxy module 128 captures packets (S101 and S102). Next, the packet analysis module 122 extracts transaction information from the captured packets and calculates a statistical value from the extracted transaction information (S103 and S104). Then, improvement measures are sought using the statistical value and are verified, whether improvement is made is determined, and when the improvement is determined as being made, the improvement measures are reported, and otherwise, when the improvement is determined as not being made, seeking improvement measures using the statistical value is repeated (S105 to S107).

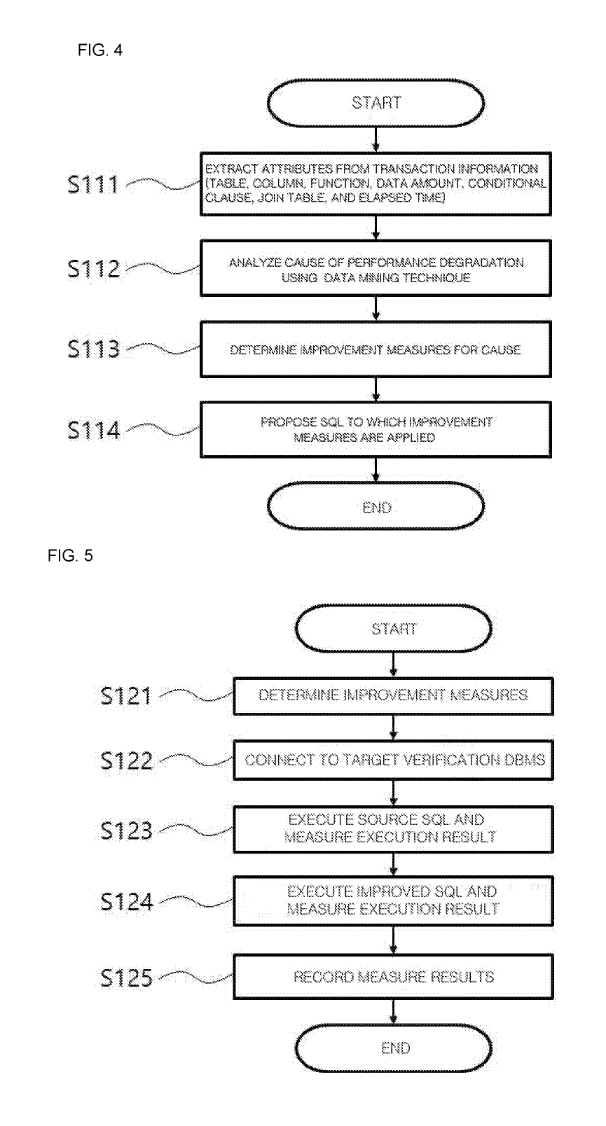

Next, a method for seeking improvement measures in the database performance monitoring system will be described with reference to FIGS. 4 and 5.

FIG. 4 is a detailed flowchart illustrating the method for seeking performance improvement measures in the performance monitoring system according to the embodiment of the present invention.

The optimizing module 124 uses values of a table, a column, a function, a data sizes, a join table, and an elapsed time of each SQL extracted from the transaction analysis module 123. The above-described values of the table, the column, and the like are referred to as SQL attributes, and correlation between an elapsed time and the SQL attribute values is found using a data mining technique so that a cause of a slow processed SQL (slow query) is found and a new SQL to which predefined improvement measures are applied is provided according to classification of the cause.

Referring to FIG. 4, the optimizing module 124 extracts attributes such as a table, a column, a function, a data amount, a conditional clause, a join table, and an elapsed time (processing time) from the transaction information and analyzes a cause of performance degradation through a data mining technique (S111 and S112). Then, improvement measures for the cause is determined, and an SQL to which the improvement measures are applied is proposed (S113 and S114).

For example, the optimizing module 124 groups a fast SQL group and a slow SQL group on the basis of an average processing time, analyzes a characteristic of the SQL for the same table by referring to a synonym dictionary and a previous optimization history, and proposes an improvement scheme by reflecting a characteristic of a fast SQL to that of a slow SQL.

FIG. 5 is a flowchart illustrating an operation of the verification module performing an actual verification of the improvement measures generated by an optimizer according to an embodiment of the present invention.

Referring to FIG. 5, the verification module 125 determines a source of a target improvement SQL and an improved SQL from the repository 126, connects to a target verification DBMS 111, executes a source SQL and the improved SQL, and compares and measures the execution result, thereby verifying whether improvement is made (S121 to S124).

Thereafter, the measurement results are recorded, the SQL determined as being improved is finally determined at an administrator console 127 of the monitoring system and is transmitted to the client terminals 20-1 to 20-N, which are actual users, thereby removing the cause of database performance degradation (S125).

Although the embodiments of the present invention have been described, those skilled in the art will appreciate that various modifications and equivalent other embodiments can be derived without departing from the scope of the present invention. Therefore, the scope of the prevent invention is not limited to these embodiments, and various modifications and improvements devised by those skilled in the art using the fundamental concept of the present invention, which is defined by the appended claims, further fall within the scope of the present invention.

What is claimed is:

1. A structured query language (SQL) tuning automation system through a statistical SQL pattern analysis, the SQL tuning automation system comprising:
an operating server configured to operate a database; and
a monitoring server configured to monitor performance by extracting transaction information including SQLs, a response time, and a processing result from a network stream transmitted between a client and the database of the operating server, find a cause of performance degradation, and propose improvement measures,
wherein the monitoring server includes:
a sniffing module configured to capture packets transmitted and received between the client and the operating server;
a proxy module configured to relay a connection between the client and the operating server and collect packets;
a packet analysis module configured to analyze the packets captured by the sniffing module and the proxy module and extract transaction information;
a transaction analysis module configured to analyze user information, a connection data base management system (DBMS) server, an SQL, and a table, a column, a function, a data amount, a conditional clause, a join table, a processing result, and a processing time which are used in the SQL from the extracted transaction information and store SQL attribute information in a repository;
an optimizing module configured to classify a fast SQL group and a slow SQL group on the basis of an average processing time stored in the repository, analyzes a characteristic of the SQL for the same table by referring to a synonym dictionary and a previous optimization history, and propose improvement measures by reflecting a characteristic of a fast SQL to that of a slow SQL; and
a verification module configured to compare and verify the improvement measures with a source SQL in an actual database,
wherein the improvement measures are proposed by monitoring performance of a target database and analyzing a cause of performance degradation.

2. A structured query language (SQL) tuning method through a statistical SQL pattern analysis, the SQL tuning method comprising:
a first operation of acquiring, by a performance monitoring server, packets from a network when the packets are transmitted and received between a user and a database;
a second operation of analyzing, the performance monitoring server, the acquired packets to extract transaction information;
a third operation of analyzing, the performance monitoring server, user information, a connection data base management system (DBMS) server, an SQL, and a table, a column, a function, a data amount, a conditional clause, a join table, a processing result, and a processing time which are used in the SQL from the extracted transaction information and storing SQL attribute information in a repository;
a fourth operation of classifying, the performance monitoring server, a fast SQL group and a slow SQL group on the basis of an average processing time stored in the repository, analyzing a characteristic of the SQL for the same table by referring to a synonym dictionary and a previous optimization history, and proposing improvement measures by reflecting a characteristic of a fast SQL to that of a slow SQL; and
a fifth operation of verifying the improvement measures,
wherein the improvement measures are proposed by monitoring a target monitoring database and analyzing a cause of performance degradation.

3. The SQL tuning method of claim 2, wherein the first operation of acquiring the packets from the network includes capturing, by a sniffing module, packets transmitted and received between a client and an operating server and collecting, by a proxy module, packets while relaying a connection between the client and the operating server.
